(19) United States
(12) Patent Application Publication
(10) Pub. No.: US 2024/0049680 A1
(43) Pub. Date: Feb. 15, 2024

(54) Animal Bed Apparatus

(71) Applicant: William Campbell Franklin, Spring, TN (US)

(72) Inventor: William Campbell Franklin, Spring, TN (US)

(21) Appl. No.: 17/972,547

(22) Filed: Oct. 24, 2022

Related U.S. Application Data
(60) Provisional application No. 63/396,647, filed on Aug. 10, 2022.

(51) Int. Cl. A01K 1/035

(52) U.S. Cl. CPC A01K 1/0353

(57) ABSTRACT

A bed for at least one animal is provided, the bed and its components are washable, the bed includes an outer ring with a floor attached to the outer ring, both made from soft material, the outer ring having rings on the outside to hang items, the bed having three layers of insert support wedges with each layer containing cushioning material, twelve insert support wedges in total, with each layer and each insert support wedge being easily removable, and with each insert support wedges able to be removed by the pet caretaker or the pet itself, resulting in many different configurations creating a customizable animal bed,

### FIELD OF INVENTION

The present invention relates to bedding for animals. More specifically, the present invention relates to bedding for animals having separate insert support wedges which are configured to make separate and independent support areas, each support area configured by adding or deleting one of three layers of shaped insert support wedges, the result being an improved support of animals while they are resting and/or sleeping.

### BACKGROUND

Bedding for animals is generally known in the art. Animal owners or caretakers use various materials for animal bedding materials including flexible rubber matting, and bladder type mattresses, mattresses filled with air, water, padding, or other materials. However, some of these other materials and associated products used as animal bedding have certain disadvantages.

For example, animal mattresses being made in one piece, typically structurally deteriorate with use. The mattresses and associated filler materials typically being to deform, for example retaining the shape of the animal. This results in the mattresses becoming less supportive of the animal, losing any cushioning effect, and the animal mattress being without any ability to change the configuration.

In addition, certain single bladder type mattresses, such as U.S. Pat. No. 6,152,077 to Bristow, can cause injuries to many animals. The fluid pressure necessary to support larger animals in these single bladder type mattresses can lead to surface instability, adversely affecting the footing of the animal during the process of lying down or standing up on the single bladder type mattress. The surface instability can cause the animal to become unsteady, fall, and/or roll over, which can lead to injury to the animal.

Besides animal comfort, maintenance issues are important. With 12 total support wedges, damaged or dirty support wedges can be replaced easily, and with this invention a new, similar, or identical configuration can be constructed with existing pieces, with dirty wedges also easily cleaned, the entire invention is machine washable.

### SUMMARY OF THE INVENTION

The present invention provides an improved animal bed supporting at least one animal, an outer bed ring, being connected to a floor, both the outer ring and the floor having cushioning material and having 12 independent support wedges with cushioning material to support an animal while sleeping. The independent support wedges are independent from one another, and include varying softness for each wedge, and come so they can be configured in three or more layers in the animal bed. The wedge sections of the bed may have varying number of wedges from one to four, and insert support wedge sections may be in any order. An additional feature is that the sections of the insert support wedges may be cut by the user or the factory, so the bed may be customized to any layout the animal prefers. Further, the disclosed animal bed may have loops on the outside of the outer ring providing a place where items may be help on the animal bed.

### PART NUMBER DESCRIPTION

1. Animal bed without any insert support wedges
2. Outer bed wall.
3. Cushioning material in outer bed wall
4. Opening in the outer bed wall
5. Floor of the animal bed
6. Cushioning material in the floor
7. First layer insert support wedge
8. First layer comprised of insert support wedges (7)
9. Cushioning material in an insert support wedge of the first layer
10. Second layer insert support wedge
11. Cushioning material in the support wedge of the second layer
12. Second layer comprised of insert support wedges (10)
13. Third layer insert support wedge, with independent support pieces
14. Cushioning material in the insert support wedges
15. Third layer comprised of insert support wedges (13)
16. Third layer insert support wedge where the wdge has been modified for animal comfort.
17. Loops on the top of the outside of the outer bed wall
18. Loops on the bottom of the outside of the outer bed wall.
19. Attachment material which may have a logo or other message on it.
20. Independent support pieces

### BRIEF DESCRIPTION OF DRAWINGS

FIG. 1 is a front view of the animal bed without loops with a front opening, and without insert support wedges, and the floor of the animal bed.

FIG. 2 is a ¾ top view of the animal bed showing the outer ring and the floor.

FIG. 3 is a ¾ top view of the animal bed with insert support wedges.

FIG. 4 is a ¾ top view of the animal bed with one complete layer of insert support wedges placed above the floor, and one insert support wedge from the second layer of the insert support wedges with the insert support wedge on the second layer placed over the intersection of the two bottom insert support wedges.

FIG. 5 is a ¾ top view of the animal bed with one complete layer of insert support wedges placed above the floor, and two insert support wedges from the second layer of the insert support wedges with the two insert support wedges on the second layer placed over the intersection of the two bottom insert support wedges.

FIG. 6 is ¾ top view that shows the loops on the top edge of the outer ring, and the bottom edge of the outer ring.

FIG. 7 is a ¾ top view of the animal bed with one complete layer of insert support wedges placed above the floor, and three insert support wedges from the second layer of the insert support wedges with the three insert support wedge on the second layer placed over the intersection of where two bottom insert support wedges meet.

FIG. 8 shows all four sections of the second layer of insert support wedges installed.

FIG. 9 shows one insert support wedge from the third layer in insert support wedges on top of bottom two layers of insert support layers. This picture shows one configuration of the top layer insert support layer where the wedge is constructed with independent support pieces. The wedge with independent support pieces can also be positioned on layer one, two or three of the insert support wedges.

FIG. 10 shows two insert support wedges from the third layer in insert support wedges on top of bottom two layers of insert support layers. This picture shows one configuration of the top layer insert support layer where the wedge is constructed with independent support pieces. The wedge with independent support pieces can also be positioned on layer one, two or three of the insert support wedges.

FIG. 11 shows three insert support wedges from the third layer in insert support wedges on top of bottom two layers of insert support layers. This picture shows one configuration of the top layer insert support layer where the wedge is constructed with independent support pieces. The wedge with independent support pieces can also be positioned on layer one, two or three of the insert support wedges.

FIG. 12 shows an attachment piece that can be attached to the outer ring and display a logo or other message.

FIG. 13 shows four insert support wedges from the third layer in insert support wedges on top of bottom two layers of insert support layers. This picture shows one configuration of the top layer insert support layer where the wedge is constructed with independent support pieces. The wedge with independent support pieces can also be positioned on layer one, two or three of the insert support wedges.

FIG. 14 shows how the insert layers can be changed not only by rearranging the insert support wedges, but also by cutting and modifying the insert support wedges.

FIG. 15 shows a side view of one layer of the insert support wedges.

FIG. 16 shows a side view of two layers on the insert support wedges.

### DETAILED DESCRIPTION OF INVENTION

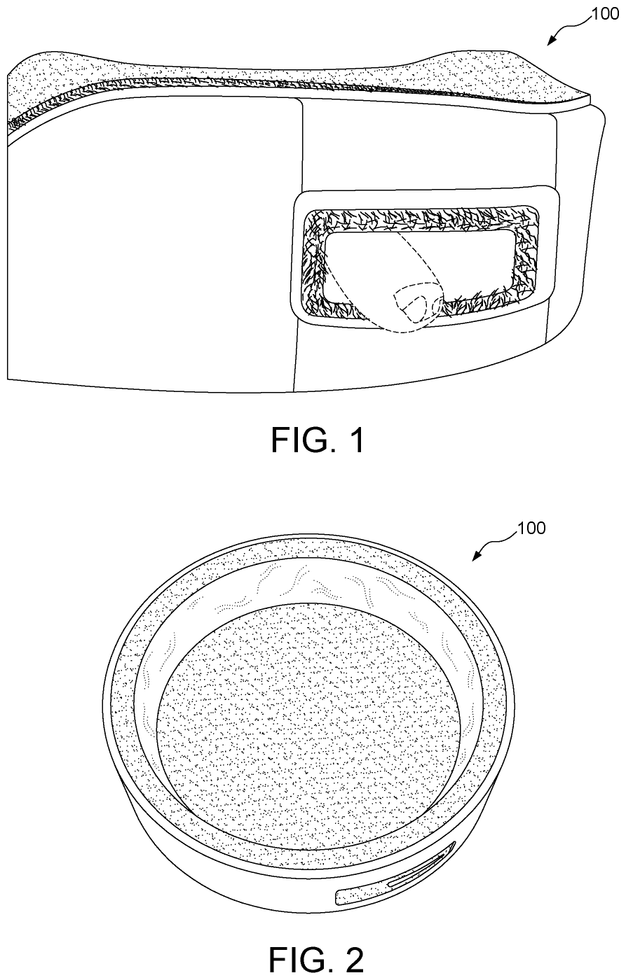

FIG. 1 depicts the front view of the animal bed 1 with an opening 4 in the front of the outer bed wall 2, with cushioning material in the outer bed wall 3.

FIG. 2 is a ¾ top view revealing the floor of the animal bed 5 and cushioning material in the floor of the animal bed 6. The animal bed 1 can be used in this configuration, without any inserts, and the cushioning material can vary between the outer bed wall and the floor.

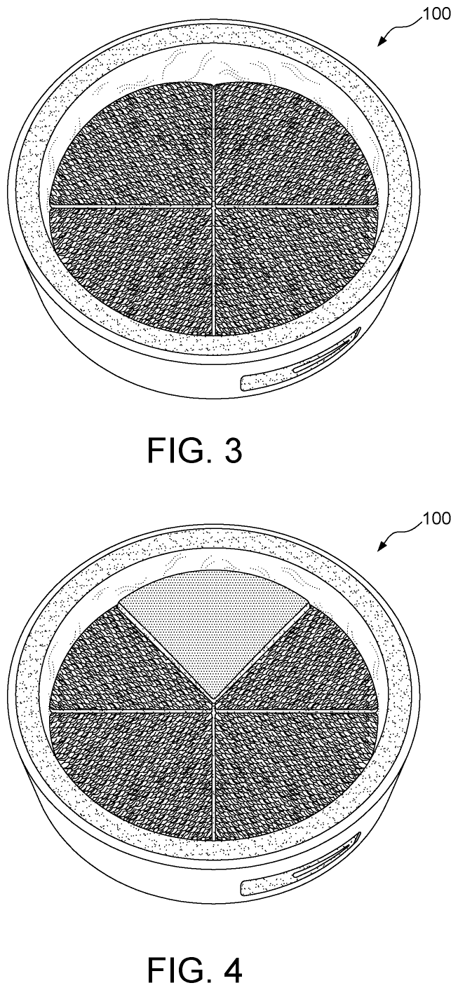

FIG. 3 shows a layer of insert support wedges above the floor and inside the outer bed wall 2, a layer of insert support wedges 8, the four insert support wedges 7, and inside the support wedges is cushioning material 9. The cushioning material does not have to be the same as the outer bed wall or the floor.

FIG. 4 shows one insert support wedge of a second layer 10, with cushioning material in the insert support wedge of the second layer insert support wedge (11). This Figure shows the one insert support wedge of the second being positioned over the area where two of the first layer insert support wedges 7 meet, but the insert support wedge from the second layer does not have to be positioned as shown. The cushioning material does not have to be the same as the outer bed wall or the floor or as the other insert support wedges from other layers.

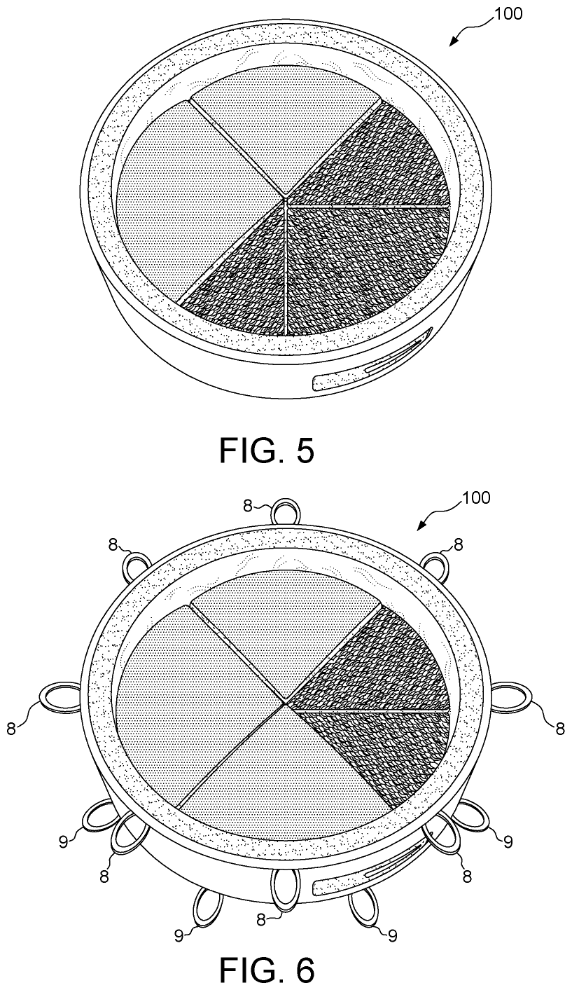

FIG. 5 shows two of the insert support wedges from the second layer 10 being positioned over the first layer support wedges 7.

FIG. 6 shows the loops 17 attached to the top of the outside of the outer bed wall 2 and the loops 18 attached to the bottom of the outside of the outer bed wall 2.

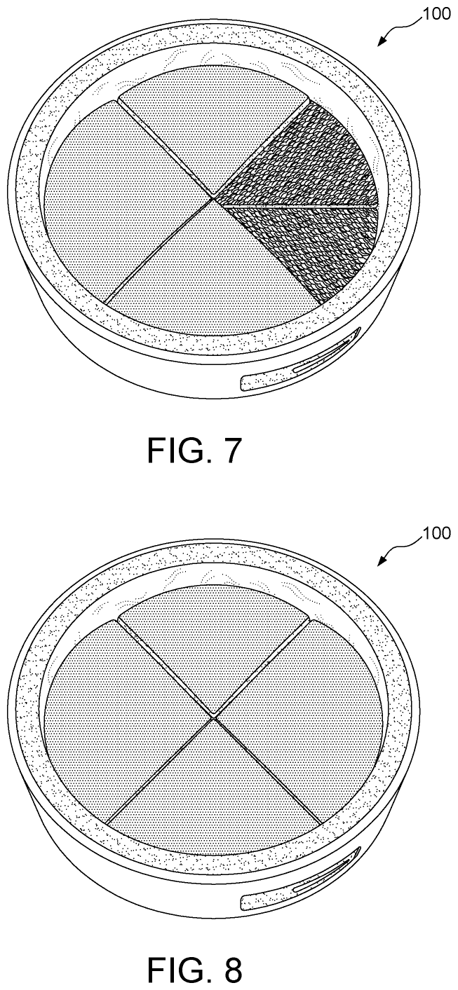

FIG. 7 shows three of the insert support wedges from the second layer 10 being positioned over the first layer support wedges 7.

FIG. 8 shows four of the insert support wedges from the second layer 10 being positioned over the first layer support wedges 7, forming the second layer 12 comprised of insert support inserts from the second layer 10.

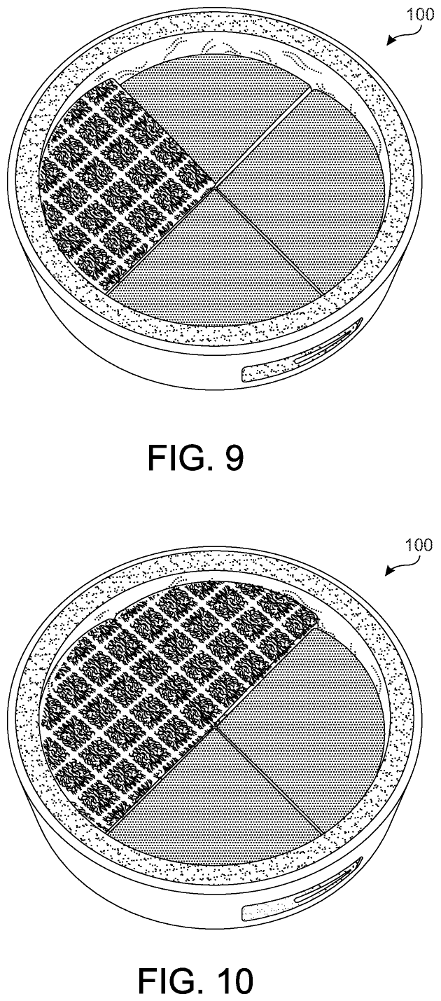

FIG. 9 shows one third layer insert support wedge 13 which is constructed with independent support pieces 19, with cushioning material in the third layer insert support wedge 14. The cushioning material does not have to be the same as the outer bed wall or the floor or as the other insert support wedges from other layers.

FIG. 10 shows two of the insert support wedges from the third layer 13 being positioned over the first layer support wedges 7 and the second level support wedges 10.

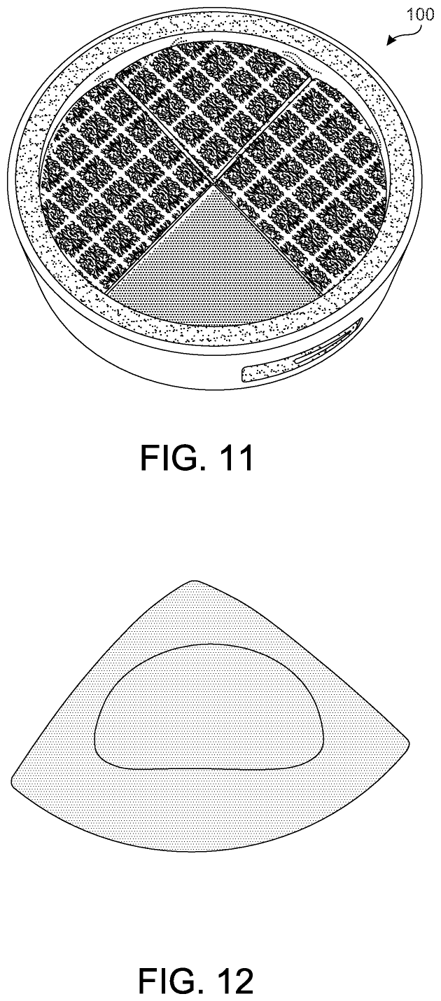

FIG. 11 shows three of the insert support wedges from the third layer 13 being positioned over the first layer support wedges 7 and the second level support wedges 10.

FIG. 12 shows an attachment piece 19 that can be attached to the outer ring and display a logo or other message.

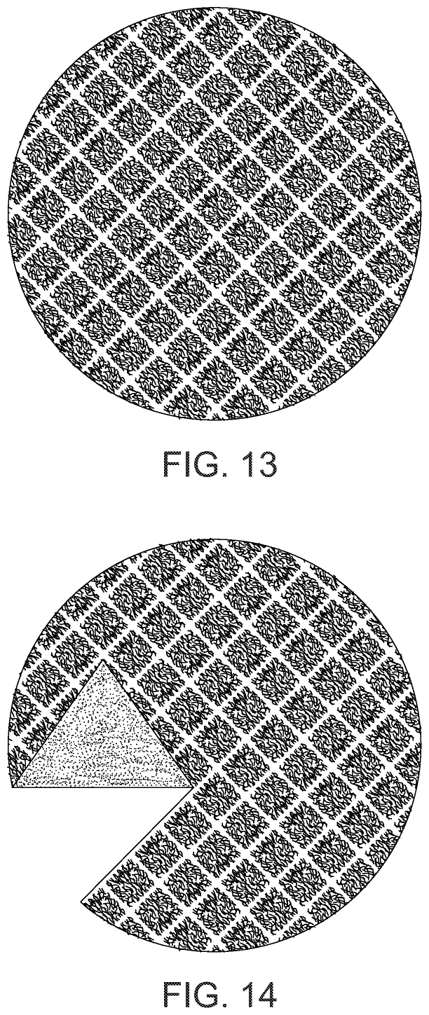

FIG. 13 shows four of the insert support wedges from the third layer 13 being positioned over the first layer support wedges 7, and the second layer 12 comprised of insert support wedges from the second layer 15.

FIG. 14 shows how an insert support wedge in the third layer 13 can be changed not only by rearranging the insert support wedges, but also by cutting and modifying the insert support wedges.

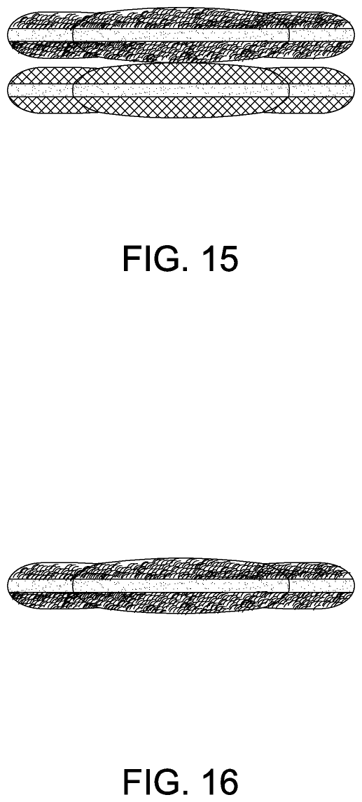

FIG. 15 shows a side view of one layer of the insert support wedges 8

FIG. 16 shows a side view of two layers on the insert support wedges 12.

The figures and description listed to this point are for several embodiments. This invention have multiple variations, of the number of layers, the configuration of insert support wedges in each layer, the order of each layer and the way the wedges can be cut, and the number of wedges that can be cut to provide the most comfort for the animal(s) using the bed. The number of possible configurations of the animal bed make it truly customizable.

What is claimed is:

1. A bed for at least one animal comprising:
an outer bed ring constructed with cushioning material;
a floor attached to the outer bed ring with cushioning material
multiple insert support wedges with cushioning material;
wherein the multiple insert support wedges can be positioned inside the outer ring in wide
variety of configurations to support a specific animal or animals.

2. The bed of claim 1 where multiple loops are attached to the top of outer bed ring.

3. The bed of claim 1 where multiple loops are attached to the bottom of the outer bed ring.

4. The bed of claim 1 where multiple loops are attached to the top and bottom of the outer bed ring.

5. The bed of claim 1 where there are multiple sets of four similar wedges.

6. The bed of claim 5 where layers of four similar insert support wedges can be made, the four similar insert support wedges able to cover the floor of the bed.

7. The bed of claim 1 where the cushioning material is some of the insert support pieces may be independent support pieces.

8. The bed of claim 1 where one or more of the insert support wedges or modified by cutting out a section of the insert support wedge.

9. The bed of claim 1 where a fabric piece displaying a logo or other symbol may be attached to the outside of the outer bed ring.
